(19) United States
(12) Patent Application Publication
(10) Pub. No.: US 2002/0101414 A1
(43) Pub. Date: Aug. 1, 2002

(54) Display device

(75) Inventors: Herbert Lifka, Eindhoven (NL); Mark Thomas Johnson, Eindhoven (NL); Freddy Roozeboom, Eindhoven (NL); Rene Johan Gerrit Elfrink, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/052,341

(22) Filed: Jan. 18, 2002

(30) Foreign Application Priority Data
Jan. 26, 2001 (EP) 01200303.4

(51) Int. Cl. G09G 5/00

(52) U.S. Cl. 345/205

(57) ABSTRACT

ICs are attached to a carrier e.g. in a bus structure or at the crossing of rows and columns. The separate crystals may contain complicated electronics (address of pixel in memory+identification).

The invention relates to a display device comprising a substrate which is provided with groups of pixels and at least one semiconductor device associated with each group of pixels.

Examples of such active matrix display devices are TFF-LCDs or AM-LCDs which are used in laptop computers and in organizers, but also find an increasingly wider application in GSM telephones. Instead of LCDs, for example, (polymer) LED display devices may also be used.

More generally, the invention relates to an electronic device comprising at least a substrate which is provided with groups of switching elements and at least one semiconductor device associated with each group of switching elements.

A general problem in these types of display devices, and more generally, electronic devices based on XY matrices is the fact that the provision of extra electronics at the area of the pixels is at the expense of the aperture. The electronics is realized on the substrate in polycrystalline silicon. Manufacturing tolerances and interconnections limit the electronics at the area of the pixels to simple functions.

To this end, the invention provides a display device comprising a substrate which is provided with groups of at least one pixel and at least one semiconductor device (IC) associated with each group of pixels, provided with means for recognizing the location and drive means for driving the semiconductor devices.

An advantage is that the ICs can now comprise drive electronics at the area of the pixels. This provides great freedom of design.

The present invention is based on the recognition that it is possible to provide the ICs at a defined position because a semiconductor substrate is provided with a plurality of semiconductor devices having electric connection contacts on their surface, which semiconductor devices are mutually separated in a surface region of the semiconductor substrate, and the electric connection contacts are connected to the conductor pattern in an electrically-conducting manner, whereafter the semiconductor devices are separated from the semiconductor substrate.

Since the location of an IC to be provided is known in advance, it can be provided in advance (during IC processing (ROM structure) or via e-PROM techniques), for example, with an address register or with one or more data registers. The address is recognized by certain ICs (and associated (groups) of pixels) and picture information is stored, whereafter it is supplied to pixels, dependent on possible further commands.

Notably, but not exclusively, when using monocrystalline silicon, it is possible to realize functions allowing a different type of architecture of the display device than the conventional matrix structure, for example, a bus structure. Since the ICs are manufactured in advance, more extensive electronic functions than in the conventional polysilicon technology can be realized, although the invention does not preclude the realization of certain functions in polysilicon technology. Consequently in the context of this patient (application) the term “semiconductor devices” also comprises separate polysilicon areas.

Since the semiconductor devices (ICs) are situated with respect to each other in exactly the same way as on the semiconductor substrate during their fixation to the substrate, these ICs are provided at a very accurate pitch. This may be a constant pitch in one direction such as in matrix-shaped configurations of the pixels. The pitch may alternatively be variable.

Moreover, the semiconductor devices (ICs) are realized in a semiconductor layer whose thickness is typically 0.2 micrometer. The result is that these semiconductor devices in the finished display device have a negligible thickness (less than 1 micrometer). In, for example, display devices based on thickness-sensitive effects such as the STN effect, this is so small with respect to the effective thickness of the liquid layer that said effects do not occur, not even in the presence of a spacer at the location of an IC.

The article “Flexible Displays with Fully Integrated Electronics”, SID Int. Display Conf., September 2000, pp. 415 to 418 describes a process in which specifically formed semiconductor devices in a liquid suspension are passed across a substrate and reach correspondingly formed “apertures” or indentations in the substrate. The semiconductor devices (usually ICs which are manufactured via standard techniques) are arbitrarily distributed across the indentations in the substrate. After the ICs have been provided, connections with pixels are established.

Since the exact position of such an IC is not known in advance, it must be fixed in a special way when using a bus structure, for example, by means of (an optical sensor and) a programmable memory so that this address information can be programmed with, for example, a laser beam.

Nevertheless, the drawback remains in these types of display devices that variations of the locations of the ICs must be taken into account. When an IC “glides into the indentations”, it may find its ultimate destination at an arbitrary location within the indentation. Consequently, the indentations occupy a much larger space than the semiconductor devices (ICs), which is at the expense of the aperture, notably in transparent display devices.

A further problem is the variation of the thickness of the semiconductor devices (ICs) related to the variation of the depth of the indentations, so that local thickness variations occur in the ultimate surface area (the common surface area of the substrate). Conductor tracks extending across the embedded semiconductor devices (ICs) in the device shown, thereby run a great risk of breakage.

These and other aspects of the invention are apparent from and will be elucidated with reference to the embodiments described hereinafter.

In the drawings:

FIG. 1 is an electrical equivalent of a possible embodiment of a display device according to the invention,

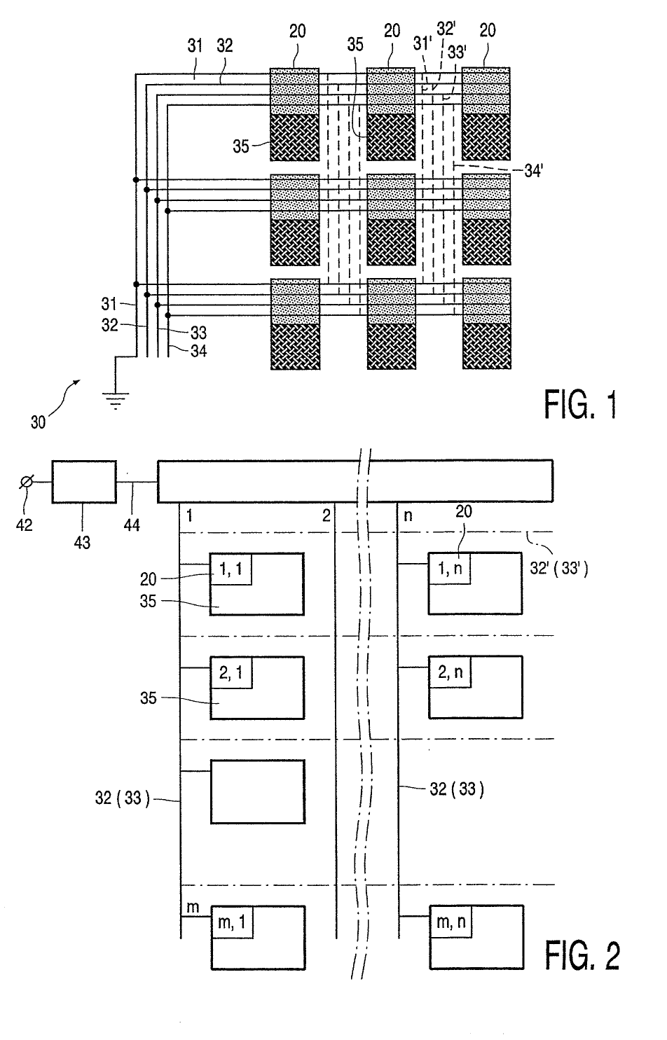

FIG. 2 is an electrical equivalent of another embodiment of a display device according to the invention,

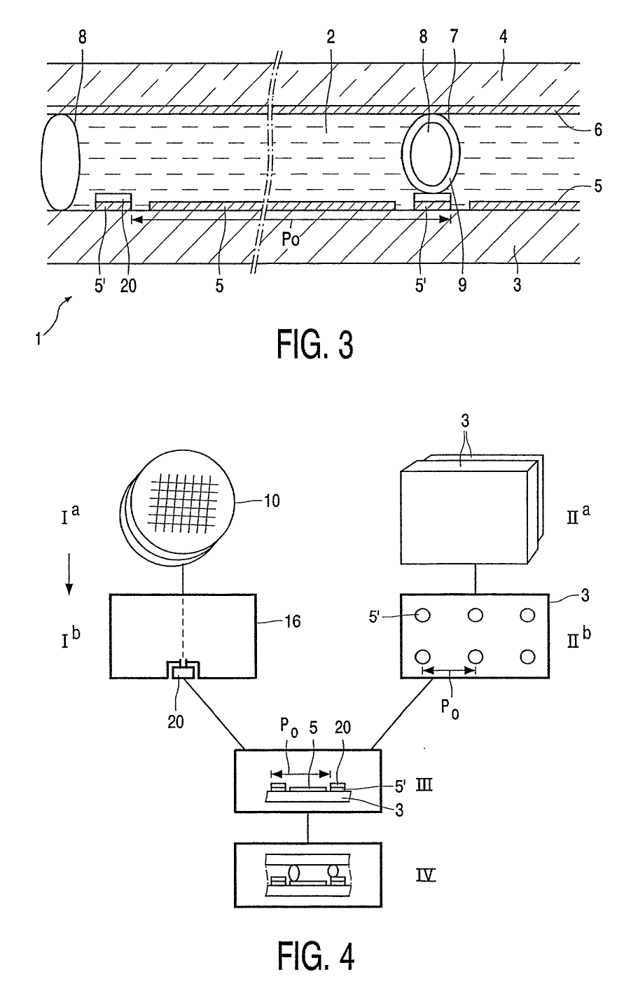

FIG. 3 is a diagrammatic cross-section of a part of a display device according to the invention,

FIG. 4 is a flow chart of the method, while

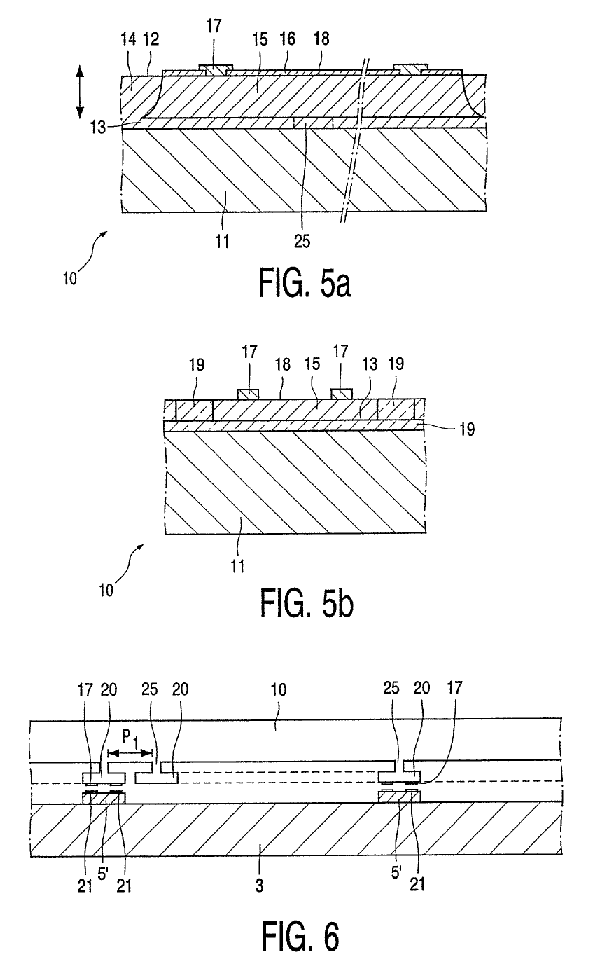

FIGS. 5a, 5b and 6 diagrammatically show steps during the manufacture of the display device of FIG. 1, and

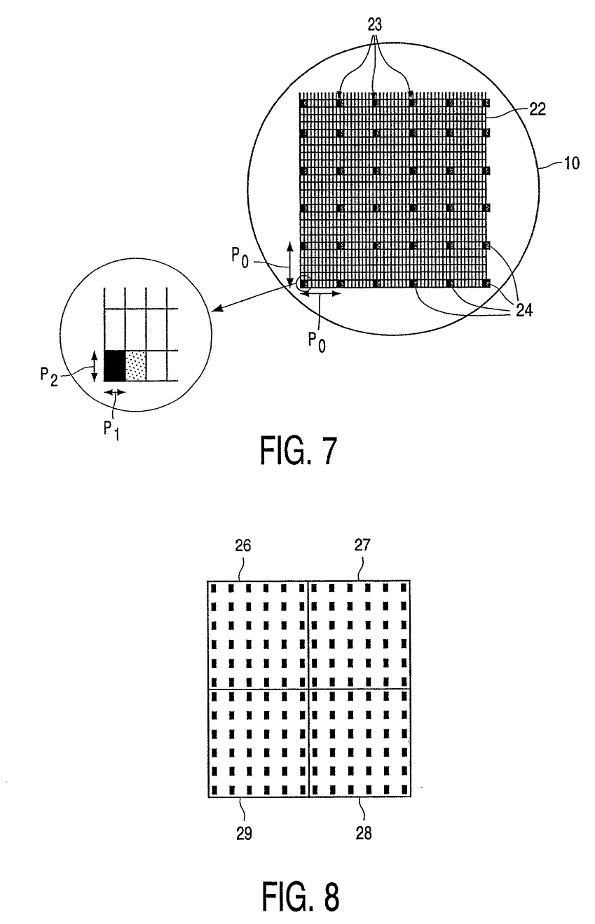

FIGS. 7 and 8 show diagrammatically the semiconductor substrate and the substrate of the display device during the manufacture of the display device.

The Figures are diagrammatic and not drawn to scale. Corresponding elements are generally denoted by the same reference numerals.

FIG. 1 shows diagrammatically an equivalent of a display device 30 having a bus structure. ICs (semiconductor devices) 20 are connected to a power supply voltage via connection lines 31, 32 (in this example, line 31 is connected to earth), while the lines 33, 34 (serially) supply information and, for example, a clock signal. The information is structured, for example, in such a way that the first bits comprise the address information and the last bits comprise the information about the picture contents. Although only two lines 33, 34 are shown, they may also form, for example, an 8-bit bus through which the address information and the picture information are consecutively passed. In this case, a lower frequency may be used, which reduces the dissipation. Alternatively, this information may be superimposed on the power supply lines 31, 32. Since, as will be further described, the location of an IC is known or not known in advance, it may be provided with a fixed address by an address register and one or more data registers. For given ICs (and associated (groups) of pixels 35), the address is recognized by the ICs and picture information is stored, whereafter it is applied to the pixels 35, dependent on commands also to be given through the lines 33, 34.

The bus structure may be formed as a mesh structure (denoted by broken lines 31′, 32′, 33′, 34′ in FIG. 1) so that the resistance is decreased (and hence again the dissipation).

Other functions may also be accommodated in the IC. For example, a part of the display device may be blocked for changes of information by means of a command register built in the IC, or may be used for storing the information in the IC for a part of the display device, but which information is not displayed (so-called “private mode”). Various algorithms for picture processing (for example, gamma correction) coding or driving may also be realized in the ICs. The ICs may jointly (or with adjacent ICs) form a distributed memory or address function.

FIG. 2 is an electric equivalent of another display device 30 to which the invention is applicable. FIG. 2 shows a plurality of pixels arranged or not arranged in groups 35 in a matrix structure. In the display device, each group 35 comprises the means for recognizing the location, for example, a command register (not shown). The command registers are in turn programmed with a given address and recognize the associated address information as described with reference to FIG. 1, when this information is presented on the bus lines 32 (33). The semiconductor device may also comprise a flip-flop in which, dependent on the state of this flip-flop, information is displayed again (“private mode”). The bus electrodes are provided with data, commands, etc. via, for example, a drive circuit 40. If necessary, incoming data signals 42 are first processed for this purpose in a processor 43. Mutual synchronization takes place via drive lines 44. Since the data, commands and other signals are now presented via a divided bus structure to the groups 35, this consumes less power (the data, commands, etc. are presented at a lower frequency). If necessary, a mesh structure may also be used again in this case.

In the relevant example, the pixels form part of a liquid crystal display device, but (O)LED display devices are alternatively possible, as well as display elements based on other effects (micromechanical effects, switching mirror devices).

FIG. 3 is a diagrammatic cross-section of a part of a light-modulating cell 1 with a liquid crystal material 2 which is present between two substrates 3, 4 of, for example, glass or synthetic material, provided with (ITO or metal) electrodes 5, 6. Together with an intermediate electro-optical layer, parts of the electrode patterns define pixels. If necessary, the display device comprises orientation layers (not shown) which orient the liquid crystal material on the inner walls of the substrates. The liquid crystal material may be a (twisted) nematic material having, for example, a positive optical anisotropy and a positive dielectric anisotropy, but may also make use of a bistable effect such as the STN effect, or the chiral nematic effect, or the PDLC effect. The substrates 3, 4 are customarily spaced apart by spacers 7, while the cell is sealed with a sealing rim 8 which is customarily provided with a filling aperture. A typical thickness of the layer of liquid crystal material 2 is, for example, 5 micrometers. The electrodes 5, 5′ have a typical thickness of 0.2 micrometer, while also the thickness of the semiconductor devices (ICs) 20 is about 0.2 micrometer in this example. In FIG. 3, a spacer 7 is shown at the location of an electrode 5′ and IC 20. The overall thickness of electrode and IC 20 is substantially negligible as compared with the thickness of the layer of liquid crystal material 2. The presence of the spacer 7 does not have any influence, or hardly has any influence, on the opto-electrical properties of the display device, notably when spacers with a hard core 8 and an elastic envelope 9 having a thickness of about 0.2 micrometer are chosen.

For manufacturing the semiconductor devices (transistors or ICs) 20, use is made of conventional techniques. The starting material is a semiconductor wafer 10 (see FIG. 4, step I^{a}, FIG. 3), preferably silicon, with a p-type substrate 11 on which an n-type epitaxial layer 15 having a weak doping (10¹⁴ atoms/cm³) is grown. Prior to this step, a more heavily doped n-type layer 13 (doping about 10¹⁷ atoms/cm³) is provided by means of epitaxial growth or diffusion. Further process steps (implantation, diffusion, etc.) realize transistors, electronic circuits or other functional units in the epitaxial layer 15. After completion, the surface in the example of FIG. 5A is coated with an insulating layer such as silicon oxide. Contact metallizations 17 are provided via contact apertures in the insulating layer by means of techniques which are customary in the semiconductor technology. An n-type region 14 (doping about 10¹⁷ atoms/cm³) is provided between the transistors, electronic circuits (ICs) or other functional units, likewise by masked doping (before or after providing the insulating layer 16).

FIG. 5B shows a variant of FIG. 5A, in which the transistors, electronic circuits or other functional units are realized in the SOI technology in which the thin surface area 15 is embedded in insulating layer 19. In the example of FIG. 5B, the contact metallizations 17 are directly provided on contact regions of the transistors of the semiconductor devices.

Subsequently, the n-type regions 14 are subjected via a mask to an etching treatment with HF (under the influence of an electric field). In this treatment, the heavily doped n-type region 14 is isotropically etched, as well as the underlying n-type epitaxial layer 13. The weakly doped n-type epitaxial layer 15 is, however, etched anisotropically so that, after a given period, only a small region 25 remains in this layer (see FIG. 3, step I^{b} FIG. 4).

The transistors, electronic circuits (ICs) or other functional units are, however, still at their originally defined position. A regular pattern of such units will generally be manufactured at a fixed pitch.

Prior to, simultaneously with or after this treatment, substrates 3 of the display device are provided with metallization patterns which (also at defined positions) will comprise one or more electrodes 5′ (FIG. 4, steps II^{a}, II^{b}). In this example, the parts 5′ of the metallization patterns on the substrate 3 are ordered similarly (the same pitch in different directions) as the electronic circuits (ICs) 20 in the semiconductor wafer 10.

In a subsequent step, the semiconductor wafer 10 is turned upside down, in which the metallization patterns 5′ on the substrate 3 are accurately aligned with respect to the electronic circuits (ICs) 20 in the semiconductor wafer 10 (FIG. 6), whereafter electrical contact is realized between metallization patterns 5′ and the contact metallizations 17. To this end, use is made of, for example, a conducting glue 21 or anisotropically conducting contacts on the electrodes 5′. The electronic circuits (ICs) 20 are detached from the semiconductor wafer 10 by means of vibration or by a different method. A substrate 3 is then obtained which is provided with picture electrodes 5 and ICs 20 which are very accurately aligned both with respect to the picture electrodes 5 and with respect to each other (step III in FIG. 4). Moreover, the reduction of aperture is exclusively determined by the dimension of the ICs (or transistors).

Not all ICs (transistors) of the substrate 10 are detached from the substrate during this step, because the pitch p₀ of the metallization patterns 5′ is usually much larger than the pitch p₁ and pitch p₂ of the ICs 20. This will be further explained with reference to FIG. 7. If the substrate 3 has a size of the order of (or smaller than) the region indicated by the block 22 of detachable ICs, only the ICs 23 (black ICs in FIG. 7) are detached and provided on the substrate.

If the substrate 3 is larger than the diagrammatically shown block 22 of detachable ICs, the ICs 23 (black ICs in FIG. 7) are first detached and provided on the part 26 on the substrate 10 (see FIG. 8). Subsequently the adjacent ICs 24 (see FIG. 7) are detached and provided on the part 27 of the substrate 10. Similarly, ICs 20 are provided on the parts 28, 29. Since their location on the semiconductor substrate is known, the ICs 20 can be provided with a fixed address by means of IC processing (for example, address 0001 for ICs 23, address 0002 for ICs 24, etc.). This may also be done at a later stage by means of, for example, e-PROM techniques.

The display device 1 is subsequently completed in a customary manner, if necessary, by providing orientation layers which orient the liquid crystal material on the inner walls of the substrate. Spacers 7 are customarily provided between the substrates 3, 4, as well as a sealing rim 8 which is customarily provided with a filling aperture, whereafter the device is filled with LC material in this example (step IV in FIG. 4).

Since the semiconductor devices (ICs) 20 are made in advance, more extensive electronic functions can be realized therein than in the conventional polysilicon technology. Notably when using monocrystalline silicon, it is possible to realize functions with which a different type of architecture of the display device can be made possible than with the conventional matrix structure.

As stated in the opening paragraph, the above-mentioned article “Flexible Displays with Fully Integrated Electronics” describes a process in which specifically formed semiconductor devices in a liquid suspension are passed across a substrate and reach correspondingly formed “apertures” or indentations in the substrate. The semiconductor devices (usually ICs manufactured by means of standard techniques) are then arbitrarily distributed on the indentations in the substrate. By allocating an address to the ICs at a later stage, similar (bus) structures can be made by means of this method.

Address information, for example, is fixed by means of an (optical) sensor and a programmable memory so that this address information can be programmed with, for example, a laser beam after forming the indentations in the substrate. It is also possible to provide these ICs with a static memory (SRAM) and realize the drive of the display device in such a way that the location of the IC in the display device (along the bus structure) is fixed via a counting mechanism and provided with an address, whenever the device is switched on.

The protective scope of the invention is not limited to the embodiments described. As stated in the opening paragraph, the pixels may also be formed by (polymer) LEDs which may be provided separately or as one assembly, while the invention is also applicable to other display devices, for example, plasma displays, foil displays and display devices based on field emission, electro-optical or electromechanical effects (switchable mirrors). Where the examples state a pitch in an orthogonal system of co-ordinates, the localization may also take place in a radial system of co-ordinates or in a tree structure (fractal structure). As already stated, the pitch may also be variable. This provides the possibility of manufacturing, for example, circular or elliptic display devices.

The examples stated the direct electric contact of the ICs on metallization patterns 5′ that were already present. Since the detached ICs have a small thickness, they may also be provided directly on the substrate 3, in which method apertures which are metallized are etched through the layers 15 by means of an etching method. The contact metallizations then extend across the ICs and make contact (for example, via contact apertures in an insulating layer) with through-metallized connections to the contact metallizations 17.

Said contacts do not need to be electrically conducting contacts. In given applications, it may be useful to provide a capacitive coupling between the contact metallizations 17 and the metallization patterns 5′, for example, by providing one or both with a thin insulating layer.

As also stated in the opening paragraph, the method is not limited to display devices. The invention is notably applicable to electronic devices (sensors) in which the substrate is provided with functional groups.

Alternatively, as stated, flexible substrates (synthetic material) may be used (wearable displays, wearable electronics).

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device comprising a substrate which is provided with groups of at least one pixel and at least one semiconductor device associated with each group of pixels, the display device being provided with means for recognizing the location and drive means for driving the semiconductor devices.

2. A display device as claimed in claim 1, wherein the means for recognizing the location have a read-only structure.

3. A display device as claimed in claim 1, wherein the means for recognizing the location comprise a programmable memory.

4. A display device as claimed in claim 1, wherein the drive means have a bus structure.

5. A display device as claimed in claim 1, wherein the drive means have a divided bus structure.

6. A display device as claimed in claim 1, wherein the semiconductor device is provided with drive electronics for supplying drive voltages to the pixels.

7. A display device as claimed in claim 1, wherein the thickness of the semiconductor device is not more than 1 micrometer.

8. An electronic device comprising at least a substrate which is provided with groups of switching elements, at least a semiconductor device associated with each group of switching elements, the electronic device being provided with means for recognizing the location and drive means for driving the semiconductor devices.

9. An electronic device as claimed in claim 8, wherein the means for recognizing the location have a read-only structure.

10. An electronic device as claimed in claim 8, wherein the means for recognizing the location comprise a programmable memory.

11. An electronic device as claimed in claim 8, wherein the drive means have a bus structure.

12. An electronic device as claimed in claim 8, wherein the thickness of the semiconductor device is not more than 1 micrometer.
